(19) United States
(12) Patent Application Publication
(10) Pub. No.: US 2005/0160157 A1
(43) Pub. Date: Jul. 21, 2005

(54) System and method for automatic device driver identification and installation

(76) Inventors: Dan L. Collier, Ridgefield, WA (US); Jeremy Bunn, Kelso, WA (US); Charles Newby, Camas, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/759,475

(22) Filed: Jan. 15, 2004

(51) Int. Cl. G06F 9/445; G06F 15/177

(52) U.S. Cl. 709/222; 717/176

(57) ABSTRACT

Systems and methods that provide for automatic device driver identification and installation. Each peripheral device to be added to a computer network or coupled to a personal computer is configured to have a uniform resource locator (URL) stored in its onboard firmware that provides direction to a location on the Internet where appropriate driver software is located and available for downloading and installation. When the peripheral device is connected to or to be used by the personal computer, the URL located in the firmware of the peripheral device is accessed. The URL automatically connects a web browser on the personal computer to an Internet site holding a driver for the peripheral device. Header information provided by the browser communicates information such as the type of personal computer and its operating system to the Internet site. The Internet site downloads a driver installation package for the peripheral device to the browser that is appropriate to the personal computer and operating system, and that is capable of implementing a driver installation process without a user specifying any option selections. The personal computer automatically initiates the driver installation process upon receipt of the driver installation package. The user is typically notified when the driver installation process is complete.

### TECHNICAL FIELD

The present invention relates generally to device driver identification and installation methods for use with personal computers, and the like.

### BACKGROUND

Typically, a distribution disk is used when installing a peripheral for use with a personal computer. A burden is placed on the user to know details about his current configuration and also to have the original installation compact disk (CD) at the user's disposal.

Currently when a user connects a peripheral device to a personal computer, he or she must have in his or her possession an installation CD that corresponds to the device to be installed as well as to the type of PC and operating system on which installation is to occur. Often the user must select the correct options from a confusing list of appropriate and inappropriate choices offered. If the user wishes to install driver software on another personal computer sometime in the future, it is a problem if the installation disk has been misplaced. If a driver update has occurred, the original distribution CD will happily offer an obsolete driver for installation.

U.S. Pat. No. 6,594,690, issued Jul. 15, 2003, entitled “Network peripheral device driver installer” discloses a “system and method install a device driver for a device. A browser is used to browse to a website where a driver resides. The browser downloads executable code. Either the browser or a user provides the executable code information about the device. The executable code builds a list of available drivers for the device from the drivers stored at the driver website. Either the executable code or a user selects a driver from the list of drivers for the device. The executable code downloads the selected driver and stores it locally. The executable code then installs the selected driver.” [See Abstract, for example].

However, this patent does not disclose or suggest anything regarding the use of firmware in a peripheral device that contains a uniform resource locator (URL) to a location on the public internet where appropriate driver software is located and available for downloading and installation.

### SUMMARY OF THE INVENTION

The present invention is directed to systems and methods that provide for automatic device driver identification and installation. In accordance with the present invention, each peripheral device to be added to a computer network or to be attached as a peripheral device to a personal computer stores in its onboard firmware a uniform resource locator (URL) to a location on the Internet where appropriate driver software is located and available for downloading and installation.

When the peripheral device is connected to or to be used by the personal computer, the URL located in the firmware of the peripheral device is accessed. The URL automatically connects a web browser on the personal computer to an Internet site holding a driver for the peripheral device. Header information provided by the browser communicates information such as the type of personal computer and its operating system to the Internet site.

The Internet site downloads a driver installation package for the peripheral device to the browser that is appropriate to the personal computer and operating system, and that is capable of implementing a driver installation process without a user specifying any option selections. The personal computer automatically initiates the driver installation process upon receipt of the driver installation package. The user is typically notified when the driver installation process is complete.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIG. 1 illustrates an exemplary system in accordance with the principles of the present invention; and

FIG. 2 is a flow diagram that illustrates an exemplary method in accordance with the principles of the present invention.

### DETAILED DESCRIPTION

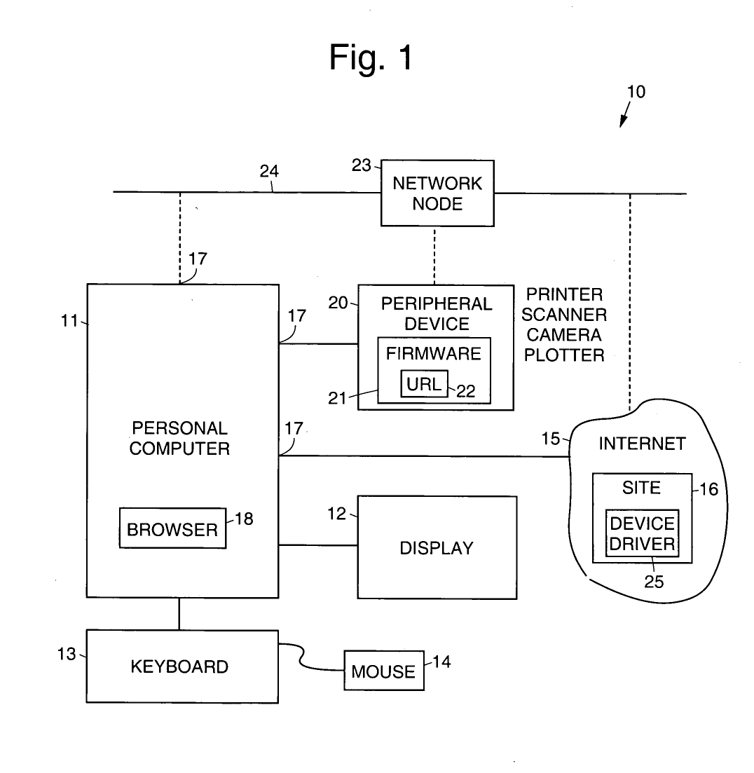

Referring to the drawing figures, FIG. 1 illustrates an exemplary system 10 in accordance with the principles of the present invention. The exemplary system 10 comprises a personal computer 11 that includes a monitor 12 or display device 12, a keyboard 13, and a mouse 14 or other pointing device 14, for example. Web browser software 18 (web browser 18) is disposed on the personal computer 11. Alternatively, or in addition, a local area network 24 having one or more network nodes 23 is provided, The personal computer 10 may be coupled to the local area network 24 by way of an appropriate communication port 17.

The personal computer 10 is coupled to a public network 15 comprising the Internet 15, either directly (using a appropriate communication port 17) or by way of the local area network 24 using another appropriate communication port 17. The personal computer 10 is also coupled to a peripheral device 20 in accordance with the present invention. Exemplary peripheral devices 20 include printers, scanners, cameras, and plotters, for example.

The present invention is operative to automatically identify and install a device driver 25 (driver software 25) for the peripheral device 20 on the personal computer 11. The peripheral device 20 comprises firmware 21 that contains a uniform resource locator (URL) 22 that directs the web browser 18 on the personal computer 10 to a location 16 on the Internet 15 (Internet site 16) where appropriate driver software 25 is located and available for downloading and installation.

When the peripheral device 20 is connected to the personal computer 11, the firmware 16 in cooperation with the operating system of the personal computer 11 launches the web browser 18 on the personal computer 11 which is directed by URL 22 to the Internet location 16 containing the driver software 25. The driver software 25 is automatically downloaded from the Internet location 16 to the personal computer 11, and is decompressed, if necessary. The downloaded (and decompressed) driver software 25 is then automatically launched and installed on the personal computer 11 without user interaction.

In addition to PC-specific OS information, printer-specific information can be communicated as well. This may be a specific model variant, or other model-specific information, for example. The resulting driver download may be more specifically tailored if printer-specific information along with specific PC information are communicated. The printer-specific information may be encoded in the URL as parameters on the end of the URL.

Thus, peripheral devices 20, such as printers, scanners, cameras, and plotters, and the like provide a URL location 22 (in firmware) from which an appropriate driver 25 is accessed and installed with minimal (if any) user intervention or interaction.

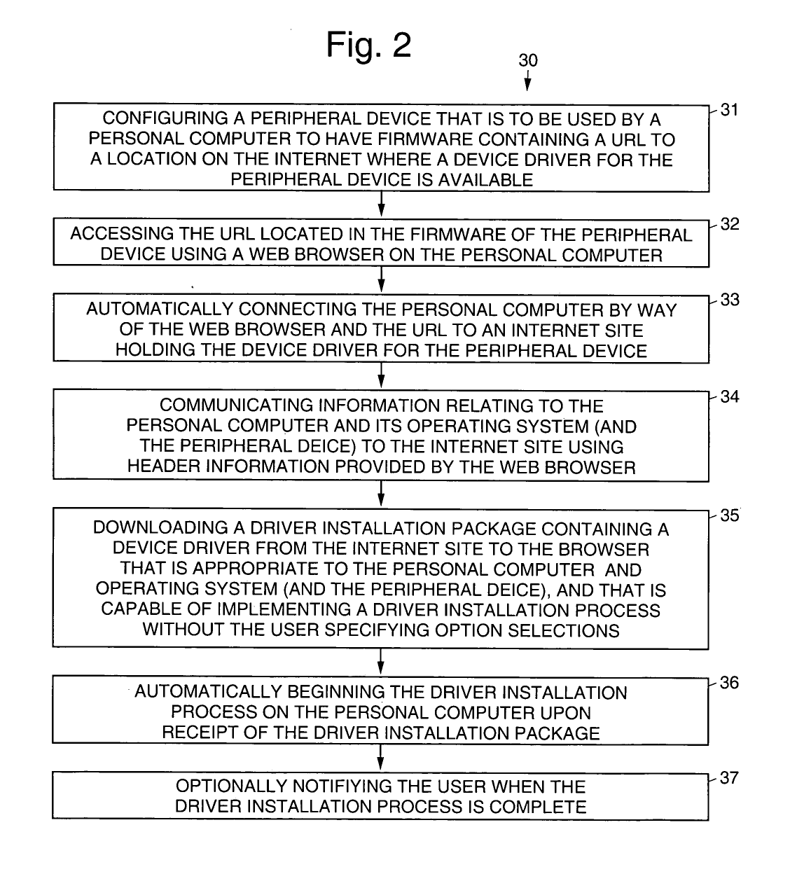

FIG. 2 is a flow diagram that illustrates an exemplary method 30 in accordance with the principles of the present invention. Each peripheral device 20 that is to be connected to a personal computer 11 (either directly or by way of a local area network 24) is configured 31 to hold or include in its firmware 21 a fully-qualified URL 22 to a location 22 on the public Internet 15 (Internet site 22) where appropriate device drivers 25 are made available for public download. A “fully qualified URL” means that the URL is complete and stands on its ownc which is usually the case unless one takes short-cuts in specifying the URL and missing pieces are derived by other means.

When a user wishes to install the peripheral device 20 (such as a camera, printer, plotter, scanner, etc.) on a network coupled to the personal computer 20, or directly to the personal computer 20, the installation process comprises the following steps.

The personal computer 11 accesses 32 the URL 22 located in the firmware 21 of the peripheral device 20. This can be done in any number of ways, including the use of low-level commands, or high level access via an embedded web server in the device capable of serving its own web pages.

Using a web browser 18 on the personal computer 11, the URL 22 is used to automatically connect 33 the personal computer 11 to the public Internet site 16 holding the device drivers 25.

Header information provided by the browser 18 in the data forwarded to the Internet site 16 is used to communicate 34 information such as the type of personal computer 11, and what operating system is used on the personal computer 11.

The Internet (driver) site 16 returns 35 or downloads 35 a driver installation package containing a device driver 25 for the peripheral device 20 to the web browser 18 that is appropriate to the personal computer 11 and its operating system, and that is capable of implementing and accomplishing a driver installation process without the user specifying any option selections.

The web browser 18 on the personal computer 11 automatically begins 36 or initiates 36 the driver installation process upon receipt of the driver installation package, and the user is notified 37 when the driver installation process on the personal computer 11 is complete.

Advantages of the present invention are that the user has no conscious part in the process of choosing and installing a device driver 25. No installation CD is required. It is a non-issue if an installation CD is lost or misplaced. Any time a driver installation is needed, it will always be the most current driver 25 available from the device vendor. The peripheral device 20 takes on the responsibility for engaging the vendor's site to retrieve and install the appropriate device driver 25. Additionally, the driver URL 22 can be used to periodically check for critical updates.

Thus, systems and methods that provides for automatic device driver installation have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A system comprising:
a personal computer comprising a web browser that provides communication between the personal computer and the Internet; and
a peripheral device coupled to the personal computer, that comprises a device driver 25, and firmware that contains a uniform resource locator (URL) that identifies and is used to direct the web browser to a location on the Internet where appropriate driver software is located and available for downloading and installation on the personal computer;
and wherein, when the peripheral device is connected to the personal computer, the URL launches a browser on the personal computer which is directed to the Internet location containing the driver software, automatically downloads the driver software to the personal computer, and automatically launches and installs the downloaded driver software on the personal computer without user interaction.

2. The system recited in claim 1 wherein the peripheral device comprises a printer.

3. The system recited in claim 1 wherein the peripheral device comprises a scanner.

4. The system recited in claim 1 wherein the peripheral device comprises a camera.

5. The system recited in claim 1 wherein the peripheral device comprises a plotter.

6. The system recited in claim 1 wherein the peripheral device is coupled to the personal computer by way of a local area network.

7. A method for use with a system comprising a peripheral device and a personal computer having a browser that provides communication, the method comprising the steps of;
configuring the peripheral device to have firmware comprising a uniform resource locator (URL) to an Internet location where appropriate device drivers for the peripheral device are made available for downloading;
using the URL and the web browser to automatically connect the personal computer to the Internet location holding the device drivers;
automatically connecting the personal computer to the Internet location holding the device drivers using the URL and the web browser;
communicating information regarding the personal computer and its operating system to the Internet location using the web browser;
downloading a driver installation package containing a device driver for the peripheral device from the Internet site to the personal computer using the web browser that is appropriate to the personal computer and its operating system and that is capable of implementing a driver installation process without the user specifying any option selections; and
automatically initiating the driver installation process upon receipt of the driver installation package to install the device driver for the peripheral device on the personal computer.

8. The method recited in claim 7 further comprising the step of:
notifying the user when the driver installation process on the personal computer is complete.

9. The method recited in claim 8 wherein the notifying step uses low-level commands.

10. The method recited in claim 7 wherein the step of accessing the URL comprises the step of using low-level commands.

11. The method recited in claim 7 wherein the step of accessing the URL comprises the step of providing high level access via an embedded web server in the peripheral device capable of serving its own web pages.

12. The method recited in claim 7 wherein the peripheral device comprises a printer.

13. The method recited in claim 7 wherein the peripheral device comprises a scanner.

14. The method recited in claim 7 wherein the peripheral device comprises a camera.

15. The method recited in claim 7 wherein the peripheral device comprises a plotter.
